(19) United States
(12) Patent Application Publication
(10) Pub. No.: US 2012/0132811 A1
(43) Pub. Date: May 31, 2012

(54) SCINTILLATOR-PHOTOSENSOR SANDWICH AND RADIATION DETECTOR AND PRODUCTION METHOD THEREFOR, EMBODYING SAME

(76) Inventors: Manfred Fuchs, Nuernberg (DE); Bernd Hauschild, Apensen (DE); Klaus Lowack, Uttenreuth (DE); Uwe Maurieschat, Lilienthal (DE); Adelbert Preissler, Uttenreuth (DE)

(21) Appl. No.: 13/301,901

(22) Filed: Nov. 22, 2011

(30) Foreign Application Priority Data
Nov. 26, 2010 (DE) 10 2010 062 040.8

(51) Int. Cl. G01T 1/20; B32B 37/12; B32B 37/14

(52) U.S. Cl. 250/361 R; 156/67

(57) ABSTRACT

In a method to produce a scintillator-photosensor sandwich for use in a pixel-resolving radiation detector for ionizing radiation, either a scintillator layer or a photosensor layer can respectively be the first and second function layers (alternatively). A transfer adhesive tape carries an adhesive layer having an exposed first side and a second side covered by protective film. The exposed side of the adhesive layer is applied onto a first of the function layers. A first lamination of the adhesive layer including the protective film onto the first function layer is implemented. The protective film is removed. A second of the function layers is then placed in contact with the second side of the adhesive layer that is situated on the first of the function layers. A second lamination of the two function layers with the adhesive layer situated between them is implemented.

### BACKGROUND OF THE INVENTION

1. Field of the Invention

The invention concerns a method to produce a scintillator-photosensor sandwich, a scintillator-photosensor sandwich, and a radiation detector with a photosensor sandwich, of the type wherein the scintillator-photosensor sandwich is produced by gluing a scintillator layer with a photosensor layer.

2. Description of the Prior Art

In the manufacture of detectors for graphical presentation of images generated by ionizing radiation for medical applications and for NDT (Non-Destructive Testing), scintillators, for example CsI:TI on Al substrates or GOS (Gadolinium oxysulfide=Gd₂O₂S) intensifier foils, are arranged over photosensors such as CMOS (Complementary Metal Oxide Semiconductor) arrays or CCD (Charge Coupled Device, i.e., a light-sensitive electronic component arrays), in particular with amorphous silicon (a-Si) technology. The scintillator layer is either only pressed on or is glued. The gluing has the advantage that more light is injected from the scintillator into the photosensor.

A production method for such a scintillator-photosensor sandwich and a radiation detector is known from the publication US 2008/0206917 A1. This publication discloses a production process for such a scintillator-photosensor sandwich for use in a radiation detector for ionizing radiation within the scope of a graphical presentation, in which process an adhesive layer is laminated onto a photosensor layer without vacuum with the use of a transfer adhesive tape. The remaining protective film of the transfer adhesive tape is removed from the adhesive layer in the procedure immediately following the lamination process, and the scintillator layer is thereupon placed on the photosensor layer provided with an adhesive layer and is glued to the photosensor layer with this adhesive layer.

This known production method is expensive, in particular due to the fact that is implemented in part under vacuum.

### SUMMARY OF THE INVENTION

An object of the invention is to provide an alternative production method for an x-ray detector or an x-ray detector element in which the combination of scintillator layer and photosensor layer is produced more simply and securely.

The invention is based on the insight that a scintillator-photosensor sandwich can be produced more easily and securely by adhering the scintillator layer and the photosensor layer to each other in two lamination steps with the use of a transfer adhesive tape. Such an adhesive tape has at least one adhesive layer that is arranged on one protective film or between two protective films. For this purpose, in a first step, after removing a lower protective film of the adhesive tape the adhesive layer is laminated on the scintillator layer or photosensor sensor between two rollers. After the removal of the second protective film, this scintillator layer, or the photosensor layer occupied by an adhesive layer, is now laminated with the photosensor layer or scintillator layer. The same lamination device is advantageously used for this.

Air bubbles can be avoided by sufficiently high contact pressure, in particular in the second lamination step, even without vacuum. The method and the lamination device necessary for this are therefore much simpler and also allow multiple sensor sandwiches to be glued successively in the same lamination device, while in the aforementioned method in the prior art only a batch production is reasonable. Typical sufficient contact pressures in the first lamination process are 1-15 kg/cm². Furthermore, in this method it is advantageous if the scintillator substrate is thinner than 0.6 mm, preferably approximately 0.3 mm, and is made from aluminum, and at least one anodized layer (also additional reflection layers) should be present on the luminophore side (thus the side of the scintillator layer). This design enables a uniform deflection, which is necessary during lamination in order to avoid air inclusions over large areas. In particular, this is advantageous when the scintillator layer with adhesive film is laminated onto the photosensor layer.

As used herein, a scintillator layer means a combination of a substrate with a scintillator material, CsI: TI, for example, deposited therein. As used herein, a photosensor layer encompasses any layer structure that generates electronic signals on a pixel-by-pixel basis from optical signals. In the description herein, both layers are designated with the term “function layers,” which (in use) includes the function of the conversion of ionization radiation into light pulses or the function of registering these light pulses.

A method in accordance with the invention to produce a scintillator-photosensor sandwich for use in a pixel-resolving radiation detector for ionizing radiation, in which either a scintillator layer or a photosensor layer can respectively be the first and second function layers (alternatively), includes the following method steps:

A transfer adhesive tape is provided that has at least one adhesive layer having a first side at which the adhesive layer is exposed and a second side covered by protective film.

The protective film-free side (first side) of the adhesive layer of the transfer adhesive tape is applied onto a first of the function layers.

A first lamination of the adhesive layer including the protective film onto the first function layer is implemented with the use of at least one roller.

The protective film is removed from the adhesive layer.

A second of the function layers is then placed in contact with the second side of the adhesive layer that is situated on the first of the function layers.

A second lamination of the two function layers with the adhesive layer situated between them is implemented, with the use of at least one roller.

A transfer adhesive tape with two protective films covering the adhesive layer on both sides can advantageously be used, wherein a protective film is removed from the adhesive layer before the placement of the transfer adhesive tape onto the photosensor layer, such that the adhesive layer directly contacts the surface of the function layer.

Furthermore, any adhesive layer that may be protruding can be separated from the scintillator-photosensor sandwich after the second and last lamination process of the function layers.

With regard to possible variants of the lamination method, a roller with a counter-roller or a roller with a counter-bar or a counter-surface can be used as a laminating device for the first and/or second lamination. For example, the counter-surface or the counter-bar can also be rotating with a resilient surface (for example a belt) forming to the opposite roller surface. Moreover, one of the rollers or the counter-bar or the counter-surface can be equipped to provide for a uniform pressure distribution across the entire roller width. Such measures are known on a larger scale from the fields of paper manufacturing and printing technology, for example.

Furthermore, the lamination process should advantageously be executed with a contact pressure from 1 to 15 kg/cm², with the contact pressure preferably being higher in the second lamination than in the first lamination.

Moreover, it is advantageous when a scintillator material on a substrate made of aluminum is used as the scintillator layer. Here the aluminum on the side of the scintillator material can be coated with an anodized layer or additional reflection layers.

The invention also encompasses a scintillator-photosensor sandwich generated according to the production method described above, and a radiation detector for ionizing radiation for imaging examination methods that has at least one such scintillator-photosensor sandwich.

### BRIEF DESCRIPTION OF THE DRAWINGS

FIG. 1 shows the beginning of the first lamination step Ia.

FIG. 2 shows the end of the first lamination step Ib.

FIG. 3 shows the beginning of a first variant of the second lamination step IIa.

FIG. 4 shows the beginning of a second variant of the second lamination step IIb.

FIG. 5 shows the beginning of a third variant of a second lamination step IIc.

FIG. 6 shows the manufactured scintillator-photosensor sandwich.

### DESCRIPTION OF THE PREFERRED EMBODIMENTS

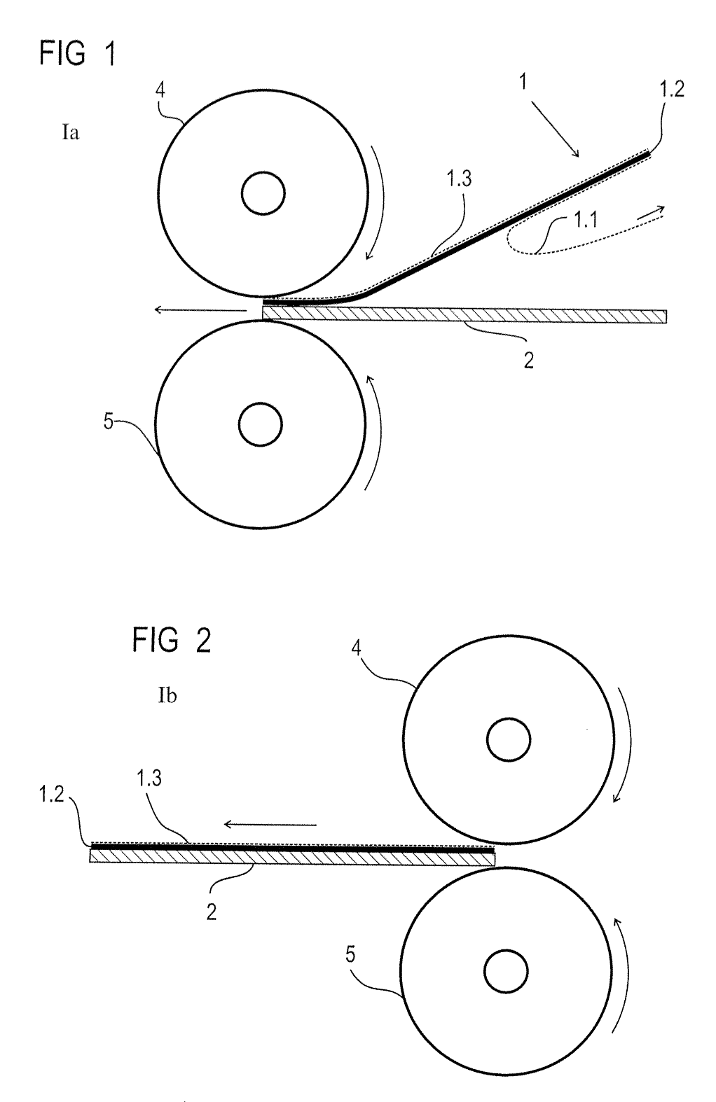

In the following the invention is described in detail with the use of FIGS. 1-6, wherein only the features necessary to understand the invention are shown. The following reference characters are used: 1: transfer adhesive tape; 1.1: first protective film; 1.2: adhesive layer; 1.3: second protective film; 2: first function layer; 3: second function layer; 4: roller; 5: counter-roller; 6: counter-surface; 7: scintillator-photosensor sandwich.

FIG. 1 shows the lamination of a transfer adhesive tape 1 comprising an adhesive layer 1.2 and two protective films 1.1 and 1.3 arranged on both sides of said adhesive layer 0.2, wherein a first protective film 1.1 (here the lower protective film) is removed immediately before the application of the adhesive layer 1.2 of the transfer adhesive tape 1, and the remaining transfer adhesive tape 1 (comprising the adhesive layer 1.2 and the protective film 1.3 arranged on top of this) is thereupon placed on a first function layer 2, for example a photosensor layer, and as a whole is inserted into the nip between a roller 4 and a counter-roller 5.

As is apparent in FIG. 2, at the end of this lamination process the complete laminate, including the first function layer 2 and the adhesive layer 1.2 laminated on this with the protective film 1.3 located on top of this, is now found after the rotating two rollers 4 and 5. Air inclusions between the function layer and the adhesive layer are avoided by this rolling, since these are pressed out with certainty by the rollers in this lamination process.

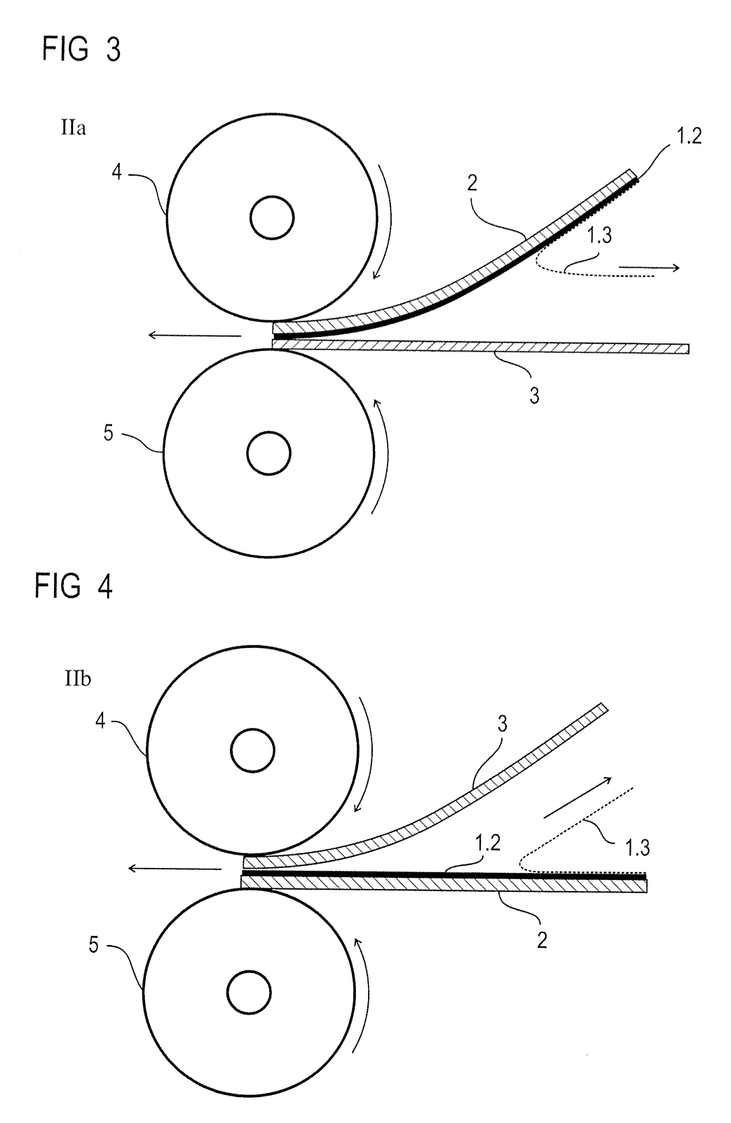

The beginning of the second lamination process now follows as it is shown in different variants in FIGS. 3, 4 and 5.

FIG. 3 shows a variant in which a scintillator sensor layer is used as a first function layer 2. This scintillator sensor layer is as a whole relatively elastically flexible due to the relatively elastic substrate on which it is arranged, such that this, together with the adhesive layer 1.2 located on it, is likewise co-laminated in a slightly arched situation onto a significantly more rigid photosensor layer 3 (that here is used as a second function layer). This co-lamination takes place between the roller 4 and the counter-roller 5 by insertion into the nip between these two rollers. Before the application of the first function layer 2 with the adhesive layer 1.2, the last protective film 1.3 is first removed from the adhesive layer 1.2. This slight curvature of the first function layer 2 in the lamination in this process of FIG. 3 is particularly suited to prevent the formation inclusions between the adhesive layer 1.2 and the second function layer 3.

A second alternative of the second lamination step is shown in FIG. 4. Here a roller 4 and a counter-roller 5 are likewise used for the actual lamination; however, in the first lamination process a photosensor layer is used as a first function layer 2, which photosensor layer is designed to be significantly more rigid than the scintillator layer that is now to be applied in the form of the second function layer 3. After prior removal of the still-present protective layer 1.3, the first function layer 2 (with the adhesive layer 1.2 arranged on it) is thus now inserted into the nip between the roller 4 and the counter-roller 5 while at the same time the slightly curved second function layer is placed and the complete sandwich is produced in the second lamination process.

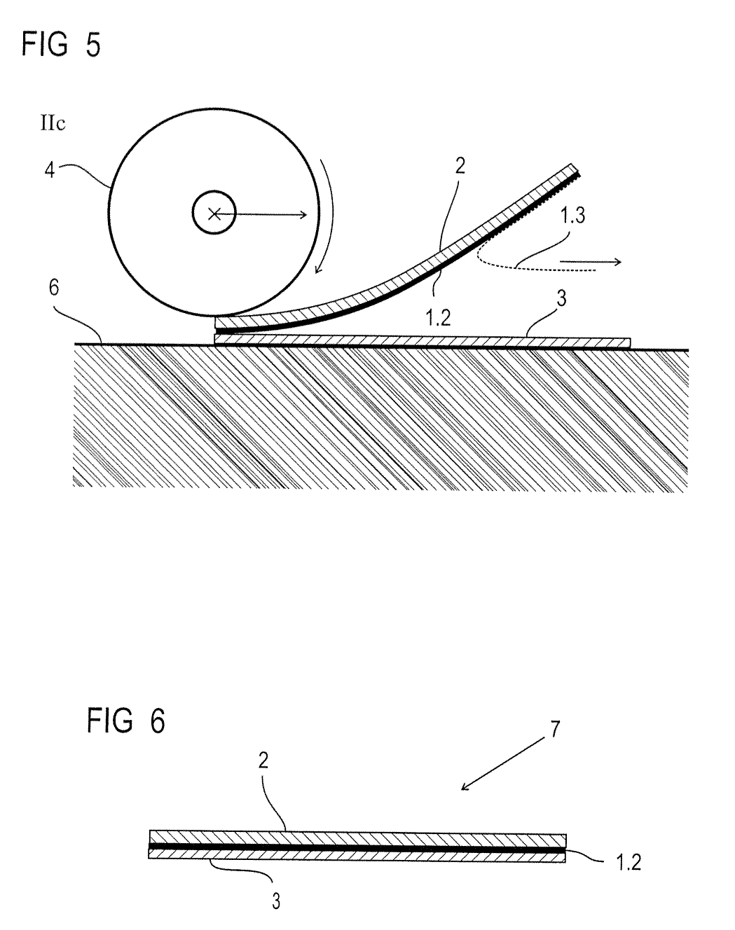

FIG. 5 shows another variant of a lamination process, here the second lamination process. Naturally, the device shown here (comprising a roller 4 and a counter-surface 6) can also be used in the first lamination process. The second, more rigid function layer 3 here can be placed on this counter-surface 6, and the (here somewhat more flexible) first function layer 2, with the adhesive layer 1.2 located on it, can be merged from above with the second function layer 3 located below it. Naturally, here a formation similar to FIG. 4 can also be used, wherein the first function layer 2 comes to lie on the counter-surface and the second function layer 3 is supplied from above.

In contrast to the methods shown in FIGS. 3 and 4, however, in this lamination method according to the invention the roller 4 is not stationary and the two function layers are not directed through the nip; rather, the roller 4 is moved along the counter-surface 6 from left to right, such that here as well a corresponding lamination process occurs via this movement and no air inclusions can arise between the adhesive layers and the function layers.

Finally, in FIG. 6 the finished scintillator-photosensor sandwich 7 is shown in a side view with the upper first function layer 2, the lower second function layer 3 and the adhesive layer 12 enclosed by the two function layers, which ensures an optimal optical contact between the two function layers.

The present invention thus shows a variant of the lamination of two function layers into a sensitive radiation detector for ionizing radiation that is easy and simple in practice, wherein the method shown here is also very well suited for a serial production since no vacuum generation is necessary in the individual method steps, and in spite of this air inclusions that are otherwise possible between the individual layers are avoided with certainty.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to produce a scintillator-photosensor sandwich for a pixel-resolving radiation detector for ionizing radiation, comprising:
providing, as a first function layer, either a scintillator layer or a photosensor layer and providing, as a second function layer, either a scintillator layer or photosensor layer not provided as said first function layer;
providing a transfer adhesive tape comprising at least one adhesive layer having a first side at which the adhesive layer is exposed and a second side, opposite said first side that is covered by a protective film;
applying said first side of said adhesive layer of the transfer adhesive tape onto the first function layer;
implementing a first lamination of the adhesive layer to the first function layer, with said protective film in place on said second side of said transfer adhesive tape, using at least one roller;
removing the protective film from said second side of said adhesive layer of said transfer adhesive tape;
thereafter placing a second function layer in contact with said second side of said adhesive layer that is situated on said first function layer; and
implementing a second lamination, after said first lamination, of said first and second function layers with said adhesive layer therebetween, using at least one roller.

2. A method as claimed in claim 1 comprising providing said transfer adhesive tape with a protective film covering said first side, and removing said protective film from said first side of said transfer adhesive tape to produce said first side of said adhesive layer at which said adhesive layer is exposed.

3. A method as claimed in claim 1 comprising separating any of said adhesive layer that protrudes from between said first and second function layers after said second lamination.

4. A method as claimed in claim 1 comprising implementing at least one of said first lamination and second lamination with a counter roller forming a nip with said at least one roller.

5. A method as claimed in claim 1 comprising implementing each of said first and second laminations with a contact pressure in a range between 1 and 15 kg/cm².

6. A method as claimed in claim 1 comprising employing a scintillator material on an aluminum substrate as said scintillator layer.

7. A method as claimed in claim 6 comprising providing said aluminum substrate with an anodized layer at a side thereof facing said scintillator material.

8. A method as claimed in claim 7 comprising providing said aluminum substrate with at least one additional reflection layer in addition to said anodized layer.

9. A scintillator-photosensor sandwich produced according to claim 1.

10. A radiation detector for ionizing radiation comprising at least one scintillator-photosensor sandwich produced according to claim 1.
